(19) United States
(12) Patent Application Publication
(10) Pub. No.: US 2017/0310817 A1
(43) Pub. Date: Oct. 26, 2017

(54) Mobile Device Inhibitor System

(71) Applicant: Lance Mckinney, Virginia Beach, VA (US)

(72) Inventor: Lance Mckinney, Virginia Beach, VA (US)

(21) Appl. No.: 15/492,885

(22) Filed: Apr. 20, 2017

Related U.S. Application Data
(60) Provisional application No. 62/325,284, filed on Apr. 20, 2016.

(51) Int. Cl. H04M 1/725; H04W 4/02; H04W 4/04

(52) U.S. Cl. CPC H04M 1/72577; H04W 4/046; H04M 1/72569; H04W 4/023

(57) ABSTRACT

A system to inhibiting mobile device function has a mobile device having one or more sensors in communication with at least one processor, wherein at least one of the sensors is an accelerometer, wherein the one or more sensors receive data, and wherein the one or more sensors instruct the at least one processor to inhibit one or more mobile device functions based on the received data. Further, a vehicle is disclosed, wherein the one or more sensors identify a location of the mobile device relative to the vehicle.

### BACKGROUND OF THE INVENTION

### 1. Field of Invention

The present invention relates to the field of mobile device functionality inhibitors.

### 2. Description of Related Art

Countless automobile accidents are attributed distracted drivers. A lack of focus during such an inherently dangerous activity can result in serious bodily injury or death. Driving under the influence of alcohol lowers inhibition and increases fatigue where a driver may take their attention off of their path for only a matter of seconds. Similarly, a driver focused on their mobile device or alerted to a mobile notification is going to be persuaded to divert their attention to the mobile device and away from their path for only a matter of seconds. It is this matter of seconds that is enough time to result in a disastrous outcome for the driver and others. While a small portion of drivers who use mobile devices make attempts to curb their use during the drive, an overwhelming majority continue to use the device or are unable to resist the urge to check for updates.

Currently, it is at the user discretion to control or establish parameters for use while driving. A driver is able to power the device down, mute the audible sounds, or quickly respond to communications with brief pre-set messages indicating that they are unable to communicate at this time. However, each of these options does not completely eliminate the user attempting to check the mobile device. Even if the device is completely powered down, the user is still only few steps away from powering the phone back on. Most often, the user may power the phone back on or look to see if any messages have come through during a pause in the driving at a stop or in slow moving traffic. Even in these situations, a brief moment of distraction can lead to accidents.

Based on the foregoing, there is a need in the art for a system to completely inhibit the use of a mobile device while the user is driving. There is a need for a device to interact or integrate with the mobile device to prohibit the functionality until it is established safe to do so.

### SUMMARY OF THE INVENTION

A system to inhibiting mobile device function has a mobile device having one or more sensors in communication with at least one processor, wherein at least one of the sensors is an accelerometer, wherein the one or more sensors receive data, and wherein the one or more sensors instruct the at least one processor to inhibit one or more mobile device functions based on the received data. Further, a vehicle is disclosed, wherein the one or more sensors identify a location of the mobile device relative to the vehicle.

In an embodiment, the data is selected from a group consisting of geographical displacement of the mobile device, audio signals, and proximity of the mobile device to a static transmitter attached to the vehicle.

In an embodiment, if the received data indicates the vehicle is moving, the received data triggers the one or more sensor instruction to the at least one processor through a method comprising the steps of the one or more sensors confirming the mobile device is located within the vehicle. Then, the one or more sensors sensing geographical displacement of the vehicle. Then, the at least one processor inhibiting one or more mobile device functions for a period of time defined by a duration of geographical displacement of the vehicle.

In an embodiment, the step confirming the mobile device is located within the vehicle further comprises the one or more sensors receiving data from a transmitter attached to the vehicle.

In an embodiment, the transmitter defines an opening of the vehicle, wherein the transmitter relays location of the mobile device to the one or more sensors based on a location of the mobile device relative to the opening of the vehicle.

In an embodiment, the step of sensing geographical displacement further comprises the steps of predetermining a threshold speed of the vehicle, wherein the processor inhibits the one or more mobile device functions when the threshold speed is exceeded.

In an embodiment, the one or more mobile device functions are selected from a group consisting of: transmission of communication between the mobile device and a remote device, image capture, and audible notifications.

In an embodiment, the data is audible and wherein at least one of the one or more sensors is a microphone, wherein the audible data has a wavelength and a frequency corresponding to at least a wavelength and a frequency produced by an engine within the vehicle.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart of the steps of the present invention, according to an embodiment of the present invention

FIG. 2 is a flowchart of the steps of the present invention, according to an embodiment of the present invention.

### DETAILED DESCRIPTION OF PREFERRED EMBODIMENTS

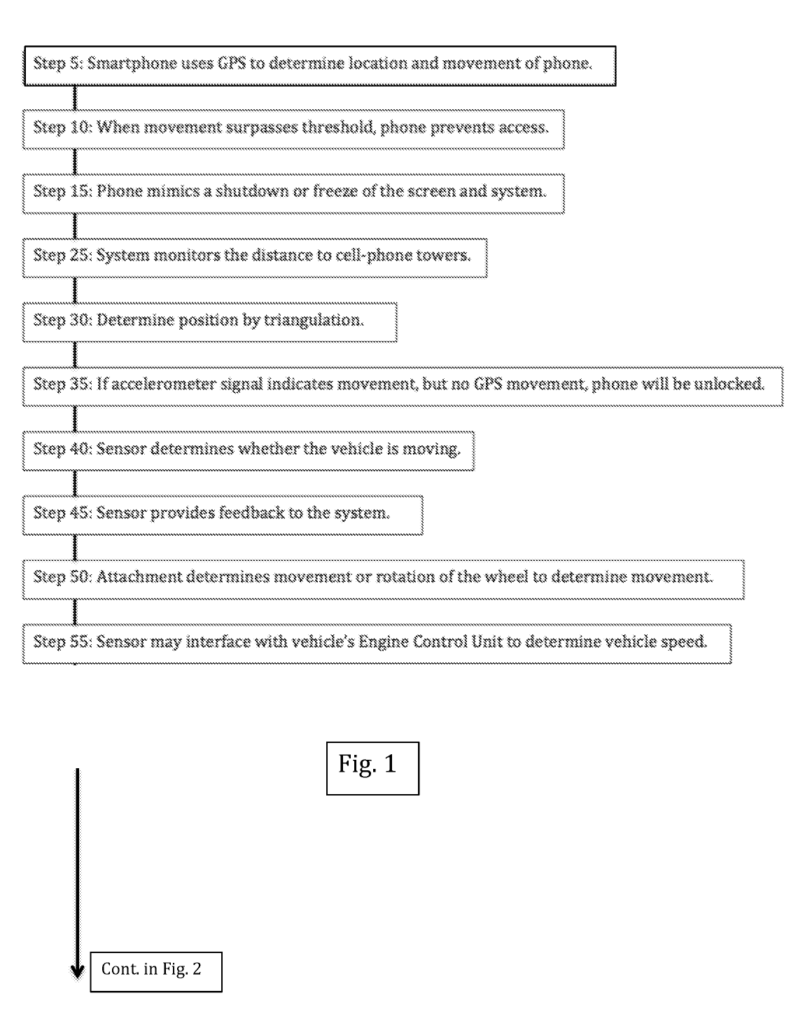

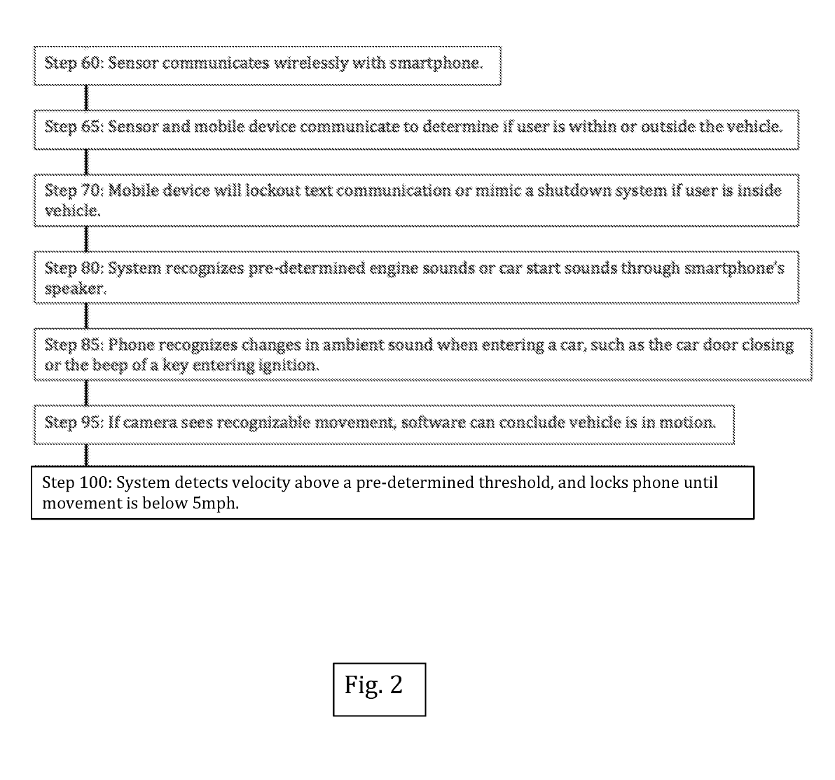

Preferred embodiments of the present invention and their advantages may be understood by referring to FIGS. 1-2, wherein like reference numerals refer to like elements.

A mobile device inhibitor has a system existing on a smartphone that detects movement of the phone and prohibits interaction with the phone. The software, which enables the phone to detect when the user is driving and prohibit access, may be implemented by hardware built into a smartphone, interface with an in-car hardware system, and/or software on an existing smartphone.

In one embodiment, the phone has hardware built in to determine if it is moving and, if so, to prevent interaction with the phone. The phone has an accelerometer therein, and monitors the accelerometer signal for a signature that indicates movement of the phone in a manner commensurate with a vehicle moving. Alternatively, or in conjunction with the accelerometer signal, in step 5 the smartphone uses the built-in Global Positioning System (GPS) equipment to determine location and movement of the phone. In step 10, when the movement surpasses a pre-determined threshold, for example 5 mph, the phone prevents access by mimicking a shutdown or freeze of the screen and system in step 15. While frozen, in step 20 the system continues to monitor the GPS signal to monitor movement. In step 25 the system also monitors the distance to cell-phone towers, and in step 30 can determine position by triangulation. In step 35 if the accelerometer signal indicates movement, but there is no GPS movement, the phone will be unlocked.

In an embodiment, a sensor is attached to the interior of a vehicle. The sensor is an elongated section of a wire structure and is electrically connected to a power source and in step 40 is communication with the vehicle to determine whether the vehicle is moving. In step 45 the sensor provides feedback to the system. An example of the vehicle communication is the physical attachment of the sensor to the steering wheel. In step 50 the attachment determines movement or rotation of the wheel and determines that the vehicle is being driven. The sensor may also interface with the vehicle's Engine Control Unit (ECU) in step 55 and determine the speed at which the vehicle is traveling. In step 60 the sensor communicates wirelessly with the smartphone when the smartphone is in proximity with the vehicle, through Bluetooth protocol, for example. Door sensors may also be present to activate the monitoring of the vehicle's wheel position and speed. In step 65, as the mobile device comes in communication with the sensor, the system is initiated within the mobile device, whereby the device appreciates the location of the mobile device and user within or outside of the vehicle. If the user is found to be within the vehicle, in step 70 the mobile device will lockout text communication or mimic a shutdown of the system.

In one embodiment, in step 80 the system recognizes pre-determined engine sounds or car start sounds through the smartphone's speaker. The recording device is initiated by GPS location of the phone in a parking lot of the street. In step 85 the phone recognizes changes in ambient sound compared with a change in the ambient sound when entering a car, such as the car door closing or the beep of a key entering the ignition. The microphone picks up the ambient sound and determines the presence of an engine “signature” for example, a low 30 Hz to 50 Hz, with a resonant 90 Hz, representing the firing of a 6-cylinder engine at idle, wherein the intensity does not vary since the smartphone remains in proximity to the vehicle, i.e. the vehicle is not moving away. Similarly, 4-cylinders and 8-cylinders may be characterized with an aural signature.

Video or photo capture device on the smartphone is similarly initiated to allow for verification that the mobile device is in a vehicle—if the camera sees recognizable movement in step 95, the software can conclude that the vehicle is in motion, and stop the interaction of the phone. In a preferred embodiment, the GPS and rate of change indicates the speed and direction of movement. If the GPS is turned off, the accelerometer in conjunction with the aural signature can determine whether the smartphone is moving within a car.

In an alternative embodiment, a locking case that prevents interaction with the phone is provided. Use of the phone may be controlled by a third party (like a parent) to lock a case around the phone where the case engages the phone through a port and the case is designed to carry out the verification of the travel and location to enable/disable the phone. The case receives feedback from the smartphone through a USB port on the GPS location and velocity, and prevents touch being transmitted through the screen protector, which is selectively blockable, and will block input when the GPS indicates movement above the threshold.

In step 100 the system detects velocity above a pre-determined threshold, for example 5 mph, and locks the phone to texting until the movement slows below 5 mph.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A system to inhibiting mobile device function comprising:
a. a mobile device having one or more sensors in communication with at least one processor, wherein at least one of the sensors is an accelerometer, wherein the one or more sensors receive data, and wherein the one or more sensors instruct the at least one processor to inhibit one or more mobile device functions based on the received data; and
b. a vehicle, wherein the one or more sensors identify a location of the mobile device relative to the vehicle.

2. The system of claim 1, wherein the data is selected from a group consisting of geographical displacement of the mobile device, audio signals, and proximity of the mobile device to a static transmitter attached to the vehicle.

3. The system of claim 1, wherein if the received data indicates the vehicle is moving, the received data triggers the one or more sensor instruction to the at least one processor through a method comprising the steps of:
a. the one or more sensors confirming the mobile device is located within the vehicle;
b. the one or more sensors sensing geographical displacement of the vehicle;
c. the at least one processor inhibiting one or more mobile device functions for a period of time defined by a duration of geographical displacement of the vehicle.

4. The system of claim 3, wherein the step confirming the mobile device is located within the vehicle further comprises the one or more sensors receiving data from a transmitter attached to the vehicle.

5. The device of claim 4, wherein the transmitter defines an opening of the vehicle, wherein the transmitter relays location of the mobile device to the one or more sensors based on a location of the mobile device relative to the opening of the vehicle.

6. The device of claim 3, wherein the step of sensing geographical displacement further comprises the steps of predetermining a threshold speed of the vehicle, wherein the processor inhibits the one or more mobile device functions when the threshold speed is exceeded.

7. The device of claim 1, wherein the one or more mobile device functions are selected from a group consisting of: transmission of communication between the mobile device and a remote device, image capture, and audible notifications.

8. The device of claim 3, wherein the data is audible and wherein at least one of the one or more sensors is a microphone, wherein the audible data has a wavelength and a frequency corresponding to at least a wavelength and a frequency produced by an engine within the vehicle.
